(19) United States
(12) Patent Application Publication
(10) Pub. No.: US 2006/0209828 A1
(43) Pub. Date: Sep. 21, 2006

(54) Interoperable communications architecture

(75) Inventors: Joseph S. Ng, Montebello, CA (US); Robert L. Simons, Troy, IL (US); William C. Beavin, Webster Groves, MO (US)

Correspondence Address: INGRASSIA FISHER & LORENZ, P.C., 7150 E. CAMELBACK, STE. 325, SCOTTSDALE, AZ, 85251, US

(73) Assignee: The Boeing Company

(21) Appl. No.: 11/083,396

(22) Filed: Mar. 18, 2005

(51) Int. Cl. H04L 12/56

(52) U.S. Cl. 370/392; 370/401

(57) ABSTRACT

A system for facilitating interoperability between a plurality of disjoint radio systems across a digital network includes one or more local gateways communicating with a network operations center. Each of the local gateways is associated with at least one radio system, and includes an interface to the digital network, a transceiver receiving wireless communications on the associated radio system, and a router configured to route at least some of the data received from the transceiver on the digital network. The network operations center processes data received from the various local gateways and forwards the processed data to the local gateways associated with the appropriate recipients. Local gateways may also be configured to convert legacy communications to digital formats, and/or may provide digital access to multiple disjoint wireless systems. The network operations center may further provide access security, network management, key management and/or other features.

### TECHNICAL FIELD

The present invention generally relates to communications systems, and more particularly relates to systems and methods for establishing and/or managing interoperability between disparate communications systems.

### BACKGROUND

Two-way wireless communications are becoming increasingly ubiquitous in personal and professional life. Wireless phones, two-way radios and other communications devices allow people to communicate from virtually any location on the globe. As communications devices and protocols evolve, immediate wireless access to voice, computer data, video and other information is also becoming more readily available.

Wireless communications are particularly beneficial to personnel involved in public safety settings such as police, fire, emergency medical and the like. Through the use of wireless communications, emergency workers can be readily dispatched to locations where they are most needed. Moreover, workers can remain in contact with each other and/or with a central office while responding to emergency events, thereby improving efficiency and safety through information sharing. Most fire, police and ambulance services, for example, typically use so-called “walkie-talkies” or other forms of two-way radios to remain in contact with each other. Wireless devices can also provide ready access to a dispatch office or other central location capable of providing command and control (C2) information.

While radio-based communications systems do provide contact to others within a department or agency, many radio-based communications systems employed by public safety agencies and others are unable to communicate with systems used by other agencies. Different agencies commonly employ radio systems that use proprietary signaling schemes, that transmit and/or receive on uniquely-assigned frequencies, that make use of uniquely-assigned cryptographic keys, and/or that are otherwise unable to communicate with each other. As a result, the communications systems used by many public safety agencies are often disparate, complex and unable to interoperate with each other. Public safety personnel are therefore frequently unable to directly communicate with personnel from other agencies, thereby reducing their ability to efficiently share information. This problem is compounded in the event of a large natural disaster or other event in which multiple local, tribal, county, state, federal and/or other agencies participate in relief or security efforts. When multiple jurisdictions and services responding to an ongoing event are unable to directly communicate, sharing of information can be hindered or prevented. Further, the lack of interoperability hinders oversight by a single management authority, thereby presenting difficulties in providing clear C2 to the multiple isolated networks used by workers responding to the event.

It is therefore desirable to provide a system for improving the interoperability of wireless and other communications networks, particularly in the public safety and emergency response environments. Additionally, it is desirable that such a system be compatible with existing wireless communications as well as emerging communications technologies. Still further, it is desirable to provide methods for establishing and managing secure communications throughout the interoperable system. These and other desirable features and characteristics will become apparent from the subsequent detailed description and the appended claims, taken in conjunction with the accompanying drawings and the foregoing technical field and background.

### BRIEF SUMMARY

Examples of network-centric systems and methods for establishing and managing secure interoperability between disjoint wireless or other communications systems are described herein. The concepts described herein are applicable across a multitude of environments including homeland security and emergency response, as well as military, intelligence, government, commercial and other settings.

In various exemplary embodiments, a <method for facilitating a wireless communication sent between a sending radio system and a disjoint receiving radio system is. processed at a network, information center that communicates with a plurality of local gateways associated with the sending and receiving radio systems via a digital network. A digital message representing the wireless communication on the sending radio system is received via the network from one of the plurality of local gateways associated with the sending radio system. The digital message is processed at the network operations center to identify an appropriate recipient for the digital message. The processed digital message is then routed over the digital network to one of the plurality of local gateways associated with the appropriate recipient for transmission to the appropriate recipient on the receiving radio system.

In various further exemplary embodiments, a gateway associated with at least one of a plurality of disparate wireless communications systems communicating via a digital network suitably includes an interface to the digital network, a transceiver and a router. The transceiver is configured to transmit and receive wireless communications on the associated at least one of the plurality of disparate wireless communications systems. The router is configured to receive data from the transceiver representing wireless communications on the at least one of the plurality of disparate wireless communications systems and to route at least some of the data on the digital network via the interface to thereby provide interoperability between the plurality of disparate wireless communications systems.

In still other exemplary embodiments, a system for facilitating interoperability between a plurality of disjoint radio systems across a digital network suitably includes a plurality of local gateways and a network operations center. Each of the local gateways are associated with at least one of the plurality of disjoint radio systems and have an interface to the digital network, a transceiver configured to receive wireless communications on the associated at least one of the plurality of disjoint radio systems, and a router configured to receive data representing the wireless communications from the transceiver and to route at least some of the data on the digital network via the interface. The network operations center has an interface to the digital network, and is configured to process the data received from the digital network to identify an appropriate recipient of the data and to route the processed data over the digital network to a receiving one of the plurality of local gateways associated with the appropriate recipient for transmission on the radio system associated with the receiving local gateway.

These and other exemplary embodiments are described more fully in the Detailed Description below.

### BRIEF DESCRIPTION OF THE DRAWINGS

The present invention will hereinafter be described in conjunction with the following drawing figures, wherein like numerals denote like elements, and:

FIG. 1 is a block diagram of an exemplary interoperable communications system;

FIG. 2 is a block diagram of an exemplary gateway to an interoperable communications system;

FIG. 3 is a flowchart of an exemplary logical process executed within a gateway; and

FIG. 4 is a flowchart of an exemplary logical process executed within a network operations center.

### DETAILED DESCRIPTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

According to various exemplary embodiments, an interoperable communications architecture suitable for radio and other forms of wireless communications includes any number of local gateways in communication with a central network operations center. The local gateways include a transceiver that transmits and receives wireless messages on a particular communications system (e.g. a police or fire system). A router present at the gateway appropriately routes communications received to other gateways and/or to the network operations center. In various further embodiments, gateways further include digital to analog and/or analog to digital conversion circuitry that converts received analog radio messages to an equivalent format that can be routed on a digital network, thereby allowing legacy radios to interoperate beyond the departmental communication system without modification to the radio itself. In still further embodiments, gateways include multiple transceivers to allow simultaneous communications with multiple wireless systems. In such embodiments, a gateway can be mounted on a vehicle, aircraft and/or other platform to allow rapid deployment of interoperable radio communications in the event of a natural disaster or other event.

Various embodiments also provide a network operations center that coordinates, manages and/or routes digital messages received from the various gateways. The network operations center allows a central authority (e.g. a municipal, county, state, federal or other agency) to oversee communications and other information provided by multiple agencies. Moreover, the network operations center is available to provide a central authority for encryption key management, access control, load balancing, network management and/or other beneficial services. By providing network-centric knowledge management capabilities at the NOC, the integration provided by the gateways can be further leveraged to provide additional benefits to supervising authorities as well as to individual responders from multiple agencies. These and other aspects of the various embodiments are described in additional detail below.

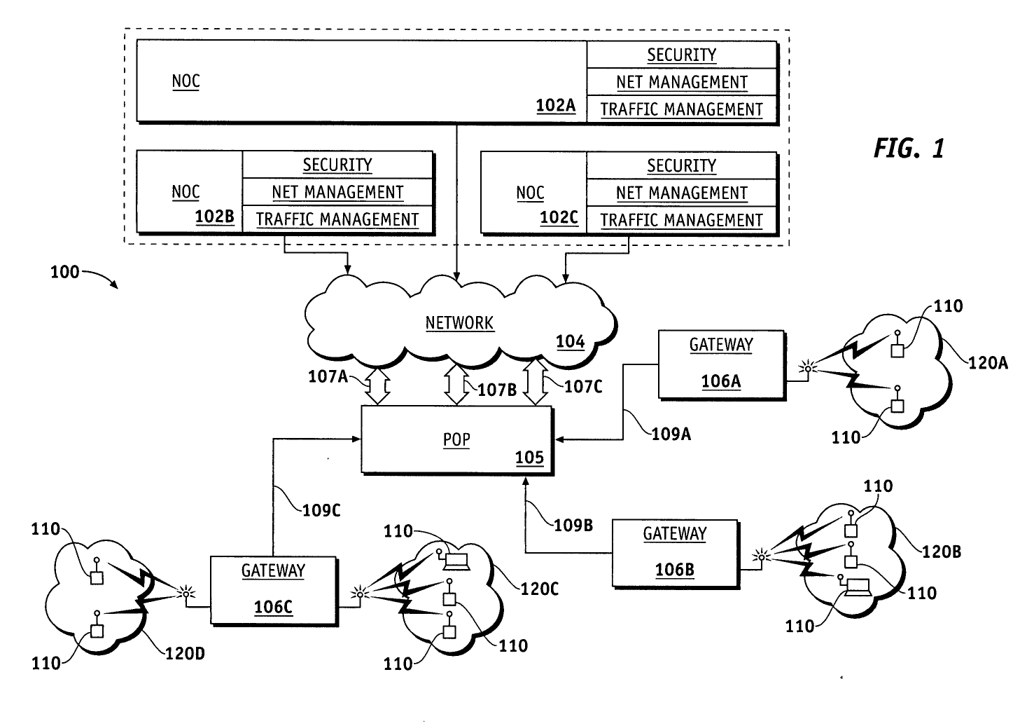

Turning now to the drawing figures and with initial reference to FIG. 1, an exemplary system 100 for facilitating interoperability between multiple disjoint communications systems 120A-D suitably includes one or more local gateways 106A-C in communication with a network operations center (NOC) 102 via a digital network 104. Each gateway 106A-C appropriately transmits and receives wireless communications within one or more associated communications systems 120A-D. Through the interaction of gateways 106A-C and NOC 102 via network 104, communications on each disjoint system 120A-D can be shared or interchanged with other systems. Moreover, NOC 102 is able to monitor communications and/or provide additional functionality as appropriate. An optional point of presence (POP) 105 may also provide access between one or more gateways 106 and network 104, although POP 105 need not be present in all embodiments.

Communications systems 120A-D are radio frequency (RF), wireless or other systems that allow digital and/or analog communications between two or more devices 110. Each system 120 may represent a radio system in use by a particular service agency (e.g. police, fire, ambulance, park service, private security, etc.), for example. Many of these agencies employ conventional two-way radio transceivers 110 broadcasting within a licensed frequency band (typically in the kilohertz, megahertz or gigahertz range), although similar concepts could be applied to digital radio frequency (RF) communications, mobile telephony, and other forms of wireless communications.

Devices 110 represent any type of handsets, radio transmitter/receivers, personal digital assistants, computers or other devices capable of communicating within one or more systems 120. Examples of devices 110 that may be used in various embodiments include conventional two-way radios (so-called “walkie-talkies”), land mobile radios, software defined radios, public digital cellular radios, and the like. Although various devices 110 are shown in FIG. 1 scattered amongst the various systems 120, the devices 110 communicating within a particularly system 120 do not typically communicate directly with devices 110 within other systems 120 due to differences in frequency, modulation or signal coding parameters, cryptographic keys, or the like.

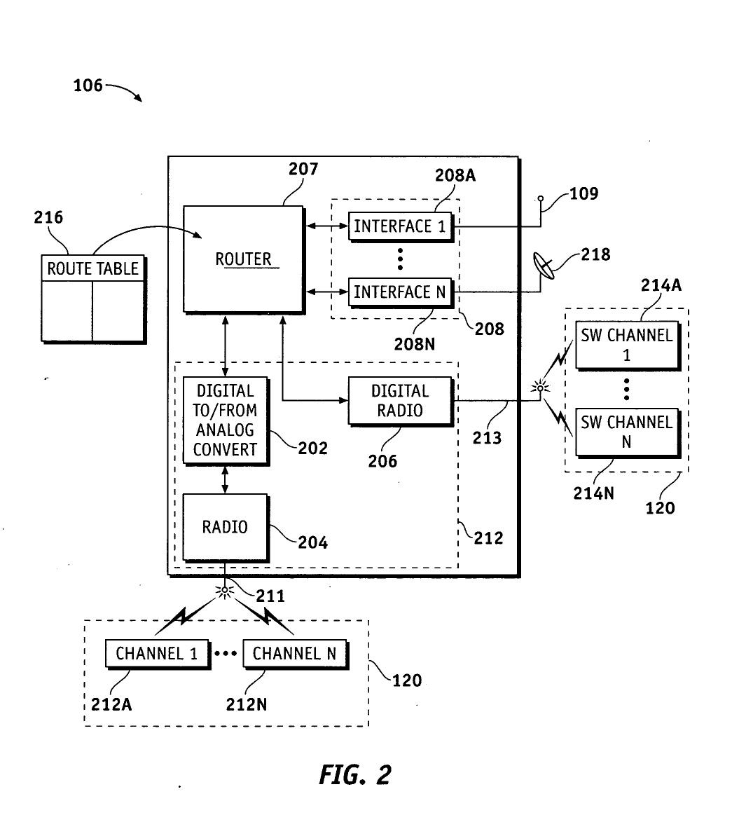

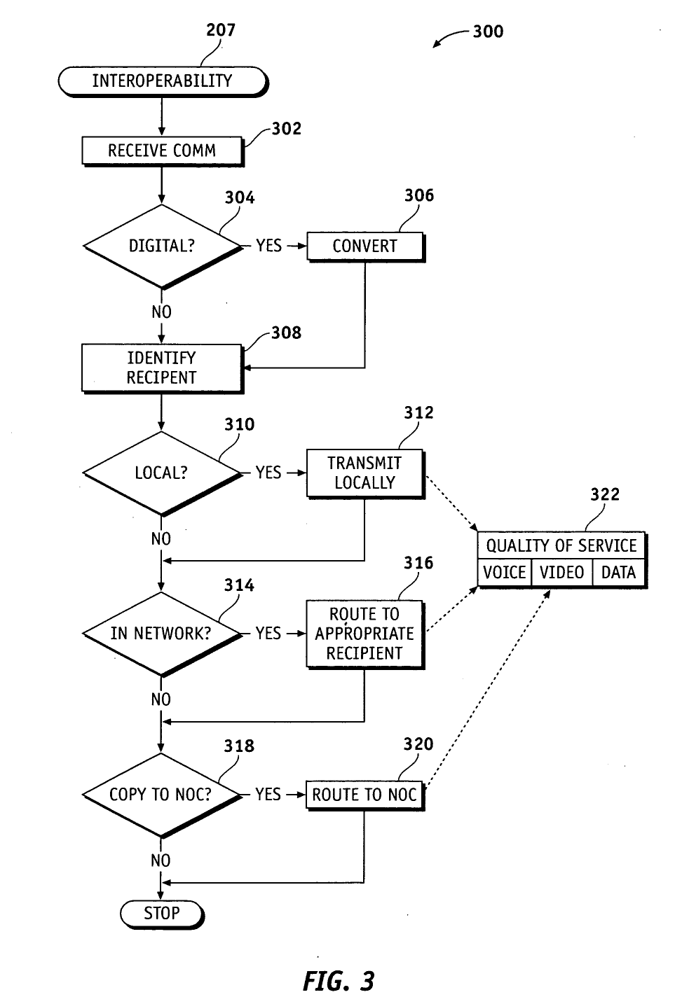

Gateways 105A-C are any devices or systems capable providing interoperability between disjoint systems 120. Gateways 106A-C may be located at any convenient location, such as at existing radio or cellular repeater, antenna, base station or the like. One or more gateways 106A-C may be alternatively placed on an aircraft, vehicle or other portable platform to allow for ready transport to an event site or other location. In a typical system 100, any number of gateways 106A-C appropriately monitor communications on one or more systems 120A-D and re-route some or all of the received communications via network 104. To that end, each gateway 106 typically includes a transmitter and/or receiver for one or more of the wireless systems 120 and an interface to network 104, as well routing hardware and/or software. The various devices 110 communicating within each system 120 operate normally, with gateway 106 monitoring communications as appropriate. Interoperability between systems 120A-D, then, is provided by converting or otherwise providing received communications in a common digital format that can be re-broadcast on a separate transceiver and/or routed on network 104. Each gateway 106 appropriately monitors communications on one or more associated communications systems 120, routes communications on network 104 using a common format (e.g. TCP/IP), and re-transmits communications received from other systems 120 as needed. Various embodiments of gateway 106 therefore allow for interoperable communications between existing radio devices 110, as well as devices 110 that operate within other systems 120 and/or that incorporate emerging technologies. Additional detail about an exemplary gateway 106 is provided in conjunction with FIGS. 2 and 3 below.

Network 104 is any digital communications media or network capable of interlinking the various gateways 106A-C with NOC 102. Network 104 operates using any appropriate protocols and/or signaling conventions such as TCP/IP. In various embodiments, network 104 is made up of any number of public and/or private data links, including any number of leased lines, satellite links, corporate or other private networks, public networks (e.g. the Internet), fiber optic connections, dial-up links and/or the like.

The number of network connections provided between gateways 106 and NOC 102 may be increased or decreased as appropriate, with some or all of the connections having redundant links. Indeed, various embodiments provide multiple links between gateways 106A-C, optional POP 105 and/or NOC 102. Redundancy and/or robustness may be provided in any manner. Each gateway 106 may connect to a point-of-presence 105 in relatively close geographic proximity (within several miles), for example, with POP 105 connecting to a regional office via a metropolitan area network (MAN) or the like. The various gateways 106A-C may have multiple data connections 109A-C to POP 105 and/or NOC 102, for example, including any number of satellite connections, point-to-point connections (e.g. laser or other optical connections, directional RF connections, etc.), spread spectrum or other wireless telephone connections, broadband connections, leased lines, and/or the like. Similarly, POP 105 may communicate with NOC 102 using any number of data connections 107A-C, including any number of satellite connections, fiber optic or other dedicated connections, manned or unmanned vehicle-based connections, connections through the public Internet and/or the like. By providing the capability for redundancy, system 100 is made more resilient to natural disasters or technology unavailability, thereby improving the robustness and flexibility of system 100. Redundant data links need not be present in all embodiments, however, and indeed one or more gateways 106 could simply connect directly to NOC 102 using, for example, a satellite link or other connection. Many alternate but equivalent embodiments could therefore be formulated that facilitate digital communications between gateways 105A-C and NOC 102 in any manner.

Network operations center 102 is any data center, network node, computer or other processing system capable of communicating with gateways 105A-C via network 104 and of providing network administration and/or management features as appropriate. In various embodiments, NOC 102 suitably provides network-centric knowledge management capability from first responders communicating via systems 120A-D to municipal, tribal, state, federal or other oversight agencies. NOC 102 may be associated with a federal department of homeland security, for example. In various embodiments, multiple NOCs 102A-C manage communications from gateways 106A-C within a particular geographic, jurisdictional or other arena. That is, multiple NOCs 102A-C may be available within system 100, with the various NOCs 102 interacting with each other and/or with gateways 106A-C in any manner. NOCs 102B and 102C in FIG. 1 could represent state management authorities, for example, with NOC 102A representing a federal agency. In such a scheme, each state management authority 102B-C could appropriately coordinate and/or monitor communications involving state, county and/or municipal agencies while providing appropriate data to federal NOC 102A. Any political, jurisdictional, geographical or other division could be similarly implemented using any number of NOCs 102 communicating in any appropriate manner.

The particular services provided by NOCs 102 vary from embodiment to embodiment. In various embodiments, NOCs 102 allow for a supervisory agency to monitor and oversee communications received from various agencies and/or from personnel on the scene of an event. This information can be displayed, recorded, logged or otherwise processed to allow the supervisory agency to made command and control decisions, to dispatch additional resources, to share information and/or to take any other actions as may be appropriate. Additionally, because NOC 102 suitably acts as a centralized point of information flow, further technological features may be provided from the central location. NOCs 102 may provide network or traffic management features such as load management and/or quality of service routing, for example. NOCs may also act as routing nodes for directing digital messages received on network 104 toward appropriate recipient gateways 106A-C and/or other destinations. Further, NOC 102 could be configured to administer various privacy and/or security features such as cryptographic key management, non-repudiation or other access control, or the like. Public keys associated with individual gateways 106, systems 120 and/or devices 110 could be stored within one or more NOCs 102, for example, to verify digital signatures received from such entities, and/or to encrypt transmitted messages intended for these recipients. Other security and/or privacy measures (e.g. router access controls, selection of secure vs. unsecure data links, etc.) could also be provided.

In operation, then, system 100 suitably provides interoperability between disparate systems 120 through the use of gateways 106A-C. As data from the disparate systems 120 is received at a gateway 106, for example, the received message is converted as appropriate to a digital format suitable for transmission on network 104. Gateway 106 may further encrypt the digital message using a symmetric or asymmetric key received from a NOC 102. The encrypted message is then routed across network 104 to the NOC 102, which decrypts the message for further processing and/or routes the message to an authorizing agency, recipient gateway 106 and/or other destination (with or without a decryption key). Such routing may take place using rules-based techniques, or according to any other manner. The receiving gateway 106 suitably decrypts the received digital message, converts the message to an analog format if necessary, and transmits the received message on the receiving communications system 120 as appropriate. The message is therefore transmitted across communications systems 120 through legacy frequency and network protocols, without modification to the transmitting or receiving devices 110 as appropriate. Alternatively, gateways 106 may be configured to support emerging standards and capabilities as they become available. Such capabilities may include, without limitation, support for IPv6 or other protocols, support for IP-based prioritization schema (e.g. multi-protocol label switching (MPLS) or the like), and/or any other features as appropriate. Further, the system 100 is suitably scalable to interact with emerging radio devices 110, as described more fully below. System 100 therefore allows for conversations and/or data exchanges across jurisdictional boundaries and/or geographic distances, and provides additional network-centric intelligence via NOC 102.

With reference now to FIG. 2, an exemplary gateway 106 suitably includes a router 207, an interface 208 to network 104 (FIG. 1), and a transceiver 212 for transmitting and receiving messages on one or more associated communications systems 120 via one or more antennas 211, 213. As stated above, gateway 106 suitably receives communications on systems 120, converts the received messages to an appropriate digital format as needed, and routes the digital messages on network 104.

Transceiver 212 is any device, system or module capable of transmitting and/or receiving signals on one or more communications systems 120. Transceiver 212 may operate according to any digital and/or analog format. In various embodiments, transceiver 212 includes a conventional analog radio 204 tuned to appropriate frequencies, coding schemes, etc. to receive communications for a particular department, agency or the like on system 120. Radio 204 may be tuned to transmit and receive on a frequency reserved for fire department communications, for example, or any other agency. Such communications may be converted to digital format using any digital-to-analog circuitry 202. In various embodiments, analog signals are converted to conventional “voice over Internet Protocol (IP)” technologies and protocols (e.g. the H.232 protocol or the like) that can be routed on network 104 by router 207. Conversion circuitry 202 also converts received digital packets to analog signals that can be broadcast or otherwise transmitted by radio 204 as appropriate. In various alternate embodiments, the digital to/from analog conversion function is performed within radio 204, in router 207, and/or in any other component of gateway 106.

Transceiver 212 may alternatively or additionally include one or more digital radios 206 capable of transmitting digital information on one or more communications systems 120. Digital information may be encoded in carrier detect multiple access (CDMA) or another format, for example. In such embodiments digital-to-analog conversion between radio 206 and router 207 may not be necessary,- although protocol conversion or the like may take place in some embodiments. Digital radio 206 may also provide the ability for router 207 to communicate directly with one or more software definable radios (SDRs) such as those conventionally found in military and other applications. Various SDRs provide multimedia and/or other data capabilities, and may be capable of communicating directly with router 207 using conventional IP or other protocols. In such embodiments, each SDR typically has a unique IP or other address that can be used to route packets to/from the device, and for other addressing purposes. SDRs may also be used to form ad hoc networks, thereby allowing gateway 106 to communicate with other SDRs that may be out of radio range of the gateway itself, but within range of another SDR operating within system 120. By including any number of digital and/or analog radios 204, 206, gateway 106 is able to communicate with any type of device 110 and with any number of otherwise disjoint systems 120.

Interface 208 suitably includes one or more connections 208A-n between router 207 and network 104. In various embodiments, multiple interfaces 208A-n are provided to establish connections with network 104 via several different media. As shown in FIG. 2, for example, interface 208A represents a wired or wireless connection 109A, while interface 208n facilitates a satellite connection 218. In alternate embodiments, any number of redundant and/or backup connections may be provided in any manner. Interface 208 may include a dedicated connection to a POP 105 (FIG. 1), for example, with a satellite or other wireless connection providing redundancy and/or backup in the event of degradation or failure of the primary connection. Types of connections 208A-n that may be utilized in various embodiments include very small aperture terminal (VSAT) or other satellite connections, leased or dial-up telecommunications connections via any wireless or wired media, laser or other point-to-point connections, fiber optic connections and/or the like.

Router 207 is any hardware and/or software capable of routing data received from transceiver 212 on network 104 via interface 208. In various embodiments, router 207 is a conventional telecommunications router available from various commercial sources. Alternatively, router 207 may be implemented with a general purpose or other computer system configured with appropriate software instructions to implement some or all of the various features described herein.

The routing function within gateway 106 may be implemented in any manner. In various embodiments, router 207 suitably includes a routing table 216 or other logical construct that includes a list of destination devices 110, gateways 106, NOCs 102 and/or the like, along with information suitable for directing data packets toward each recipient in the list. Such information may include an indication of an interface 208A-n, radio 204, 206 or other “next hop” identifying a path to the destination, and/or may contain other routing information as appropriate.

In various embodiments, router 207 redirects some or all of the information received from transceiver 212 to NOC 102 (FIG. 1) via interface 208. Router 207 may additionally or alternatively route data to other gateways 106, and/or between radio links 204, 206 within a single gateway 106. Because router 207 is able to receive information transmitted from each communications system 120, this information can be re-directed and/or re-transmitted on other systems 120 as appropriate, thereby providing interoperability between systems 120. Additional detail about an exemplary routing process is described in conjunction with FIG. 3 below.

In various further embodiments, separate analog channels 212A-n and/or digital channels 214A-n are used to further enhance the routing features within gateway 106. Router 207 may be configured to forward only data received on certain channels, for example, to allow personnel operating within each system 120 to determine whether their communications should be forwarded. For example, if only channel 212A of network 120A is to be shared with other networks 120, then communications received on the other channels may be ignored or otherwise processed separately from those received on channel 212A. Alternatively, information received from other systems 120 may be broadcast only on certain channels, thereby allowing users to enable or disable out-of-system communications as desired. In still further embodiments, communications received on all channels 212A-n, 214A-n are forwarded to NOC 102, whereas only communications on certain channels are routed to other systems 120. Many other signal or channel-based routing schemes could be formulated in a wide array of equivalent embodiments.

As briefly noted above, gateway 106 may be configured in many different ways to suit a variety of purposes and environments. In various embodiments gateway 106 may be used even in isolation from network 104 to provide interoperability between two or more systems 120, for example. Such functionality may be particularly useful in emergency response situations in which connections to network 104 may be unavailable, yet it is still desirable to provide interoperability between first responders using disjoint radio systems 120. In various further embodiments, a gateway 106 having radios 204, 206 associated with various local or regional response agencies may be configured on a helicopter, vehicle or other portable platform to allow rapid deployment to the site of an emergency. Such embodiments may include a VSAT or other satellite terminal 218, for example, to facilitate connections to network 104 from even very remote locations. In other embodiments, gateway 106 may be located at a repeater, antenna, base station or the like to provide connectivity to network 104 for one or more particular systems 120.

With reference now to FIG. 3, an exemplary process 300 for establishing interoperability between various disjoint communications systems 120 suitably includes the broad steps of receiving communications from the radio system (step 302), converting the received communications into digital format if appropriate (steps 304, 306), and routing the digitally-formatted data to an appropriate recipient within and/or external to the gateway (steps 308-322). Process 300 as shown in FIG. 3 is not intended as a literal implementation, but rather as a logical representation of the various functions carried out within an exemplary gateway 106. As such, the various processing steps may be supplemented, combined, removed or otherwise modified in various practical embodiments.

Gateway 106 suitably receives analog or digital communications from one or more systems 120 in any appropriate manner (step 302). Communications may be received via transceiver 212, for example, as described above. If communications are received in an analog format or other format that is incompatible with direct routing on network 104, analog-to-digital conversion (step 306) and/or other format translation may take place as appropriate. Voice communications, for example, may be converted to H.232 or other voice-over-IP formats, video data may be compressed or otherwise reformatted, or the like. In other embodiments, digital data is received directly from software-defined radios or other digital devices 110.

As digital data associated with the communications on one or more systems 120 is received, router 207 suitably identifies an appropriate recipient for the information (step 308). Recipients may include other systems 120 associated with the receiving gateway 106 (steps 310), systems associated with other gateways 106 (step 314), NOC 102 (step 318) and/or any other recipients. In various embodiments, digital data is forwarded to NOC 102 (step 320) for monitoring by an oversight agency, as well as directed to an appropriate transceiver 212 for re-transmission on one or more systems 120. The re-transmitting transceiver 212 may be located within the same gateway 106 that received the original communication (step 316) and/or may be located within a separate gateway 106 accessed via network 104 (step 314).

Router 207 may further provide encryption or other security features as part of steps 316 and/or 320. Communications between gateway 106 and NOC 102, for example, may be encrypted using any symmetric, asymmetric or other cryptographic techniques. In a symmetric encryption environment, NOC 102 and gateway 106 generate and exchange symmetric keys according to any technique. One example of a key exchange protocol is set forth in Internet RFC 2409, although any key exchange technique could be used in alternate embodiments. In an asymmetric encryption environment, each gateway 106 and NOC 102 has an associated public/private key pair, and messages transmitted across network 104 are encrypted with the recipient's public key. Public/private key pairs may also be used to positively identify devices transmitting and receiving messages within system 100 using conventional digital signature techniques.

Router 207 may provide further security through the use of router access controls or other techniques. Such embodiments may be particularly beneficial in closed networks, for example, wherein external access is limited to discrete persons or locations. In such embodiments, router 207 limits distribution of messages to NOC 102 and/or certain gateways 120 that are known by router 207 to be accessible via secure links. Router access restrictions may be coupled with authentication or digital signature validation to further support multiple services and/or multi-class users.

In various further embodiments, router 207 provides quality-of-service functions (step 322) in addition to general routing of data. Because different types of data transported on network 104 may have different priorities or requirements, router 207 may select data connections and/or routing parameters as appropriate for the various types of data being routed. Voice traffic, for example, is typically relatively delay sensitive, yet does not require significant bandwidth or quality. As a result, voice traffic may be given highest routing priority, but may be routed over lower-bandwidth connections. Video data, in contrast, is typically relatively high bandwidth but low priority, and different types of data traffic may have varying quality-of-service demands. As a result, router 207 may consider the type of data being transferred when selecting appropriate routing paths in order to provide improved quality of service for all types of traffic. QoS functionality may be implemented using any conventional techniques (e.g. MPLS or the like).

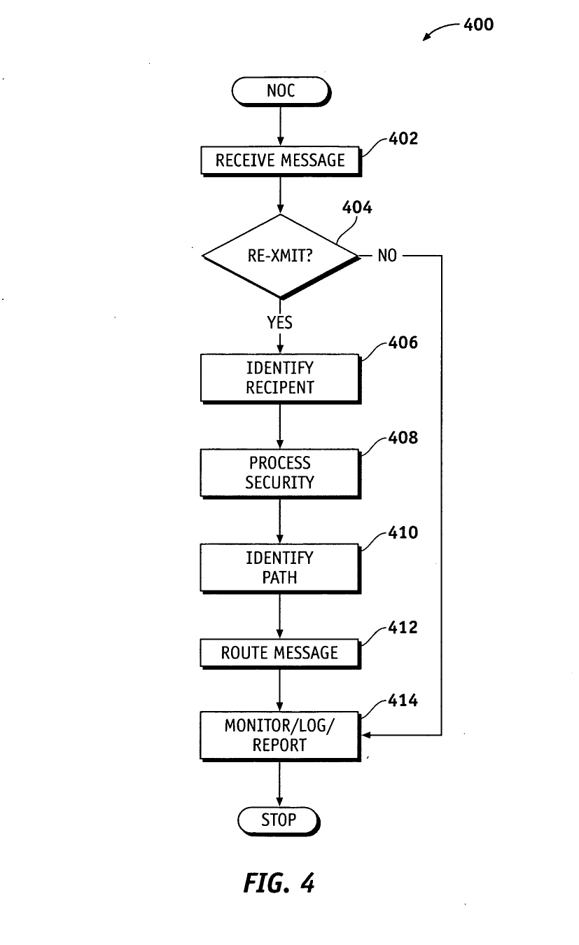

Turning now to FIG. 4, an exemplary process 400 executed at NOC 102 suitably includes the broad steps of receiving a digital message (step 402), routing or otherwise retransmitting the message as appropriate (steps 404-412), and providing for monitoring or logging by a supervisory authority (step 414). As with process 300 discussed above, process 400 is not intended as a literal hardware or software implementation, but rather as a logical representation of various functions carried out by an exemplary NOC 102. The various steps shown in FIG. 4 may therefore be executed in any temporal order, and indeed may take place simultaneously or otherwise in a different manner from that set forth in FIG. 4 in various equivalent embodiments.

NOC 102 receives digital messages via network 104 containing packets of data from various gateways 106 and/or other sources (step 402). Step 402 may also involve decrypting the received data, processing a digital signature or other credential to verify the identity of the party or device sending the message, or taking other appropriate steps to preserve the security of system 100. In various embodiments, NOC 102 provides a routing function that re-directs received data packets to other recipients. In other embodiments (step 404), however, NOC 102 simply receives the digital data from gateways 106 and processes the information contained therein locally, as described more fully below. Routing functions within system 100 (FIG. 1) may therefore be shared or allocated between NOC 102, gateways 106 and/or other devices operating within network 104 in any manner.

To implement an exemplary routing function, NOC 102 suitably identifies a recipient for the message (step 406), processes digital signatures, encryption and/or other appropriate security mechanisms (step 408), identifies a proper path for the message (step 410) and forwards the message along the identified path (step 412) as appropriate. After receiving a message for further routing, the intended recipient of the message is determined (step 406) in any manner. The received digital data may identify the receiver in a header or other data field, for example. Alternatively, rules-based logic at NOC 102 can be used to forward all packets having particular parameters (e.g. all packets originating from a particular device 110, system 120 or gateway 106, all packets containing a certain type of voice or data content, or the like) to certain destinations. All fire department traffic could be forwarded to a police or ambulance channel, for example, while only certain channels of law enforcement traffic are forwarded. Rules could be formulated based upon point of origin, departmental or other political constrants, geographical boundaries, or any other factors.

When the recipient(s) of the message are identified, NOC 102 provides appropriate security measures for the message.. The message may be encrypted with a recipient's public key and/or a shared key, for example, and/or the message may be digitally signed with a private key associated with the NOC to prove that the message originated with the NOC. Not all messages will typically contain confidential or sensitive data, however, so security parameters and techniques used will vary significantly from embodiment to embodiment.

NOC 102 also determines an appropriate path through network 102 to the recipient. The path may be determined using quality-of-service techniques, as described above. In such embodiments, the content of the message is considered in determining which of several available data paths are most appropriate. Security may also be a consideration in path determination, in that highly sensitive messages may be transmitted over more secure links (e.g. leased lines or other point-to-point connections) rather than public networks, broadcast media or the like. The message is then transferred along the identified path in any appropriate manner (step 412).

A significant benefit of various NOCs 102, however, is the ability to monitor, log and report on communications occurring from various departmental communications systems 120 (step 414). Because each gateway 106 is capable of converting legacy and other communications within each departmental system 120 to a digital format that can be routed on network 104, NOC 102 suitably acts as a central repository for such information. Such information can be highly useful in a command and control center, for example, which may have a need to monitor and direct the actions of individuals from multiple organizations responding to a natural disaster, terrorist attack or other significant event. Further, a centralized point of information flow allows inter-departmental information to be readily transferable, thereby facilitating network-centric operations of various types. To name just a few examples, a local police officer could transfer a picture of a suspect or license plate during a routine traffic stop using a departmental radio, and this information could immediately be compared against federal crime records or the like. A firefighter trapped in a burning building may be able to obtain directions to safety by conversing directly with a private security guard, zoning officer, or other person with access to building layout information. Alternatively, a map of the building could be transmitted to the firefighter via his departmental radio. Firefighters from multiple state and federal agencies responding to a large forest fire, for example, could speak directly with local firefighters via their departmental radios to identify hydrant locations, to inquire about regional terrain, or the like. In each case, a centralized NOC may monitor communications from all agencies, and/or provide additional data as appropriate.

While at least one exemplary embodiment has been presented in the foregoing detailed description, it should be appreciated that a vast number of variations exist. It should also be appreciated that the exemplary embodiments discussed above are only examples, and are not intended to limit the scope, applicability, or configuration of the invention in any way. Rather, the foregoing detailed description will provide those skilled in the art with a convenient road map for implementing the exemplary embodiments, and various changes can be made in the function and arrangement of elements without departing from the scope of the invention as set forth in the appended claims and the legal equivalents thereof.

What is claimed is:

1. A method for processing a wireless communication sent between a sending radio system and a disjoint receiving radio system at a network operations center, wherein the network operations center communicates via a digital network with a plurality of local gateways associated with the sending and receiving radio systems, the method comprising the steps of:
receiving a digital message via the network from one of the plurality of local gateways associated with the sending radio system, the digital message representing the wireless communication on the sending radio system; and
processing the digital message at the network operations center to identify an appropriate recipient for the digital message; and
routing the processed digital message over the digital network to one of the plurality of local gateways associated with the appropriate recipient for transmission to the appropriate recipient on the receiving radio system.

2. The method of claim 1 further comprising the step of verifying the security of the digital message.

3. The method of claim 2 wherein the verifying step further comprises verifying a digital signature contained in the digital message.

4. The method of claim 1 further comprising the step of identifying a path to the appropriate recipient.

5. The method of claim 4 wherein the identifying step comprises identifying the path based at least in part upon a quality-of-service associated with the digital message.

6. The method of claim 4 wherein the identifying step comprises identifying a secure pathway to the one of the plurality of local gateways associated with the appropriate recipient and the routing step comprises routing the digital message along the secure pathway.

7. The method of claim 4 wherein the identifying step comprises identifying the path based at least in part upon load balancing considerations.

8. The method of claim 1 further comprising the step of forwarding the digital message to an overseeing authority at the network operations center.

9. A gateway associated with at least one of a plurality of disparate wireless communications systems communicating via a digital network, the gateway comprising:
an interface to the digital network;
a transceiver configured to transmit and receive wireless communications on the associated at least one of the plurality of disparate wireless communications systems; and
a router configured to receive data from the transceiver representing wireless communications on the at least one of the plurality of disparate wireless communications systems and to route at least some of the data on the digital network via the interface to thereby provide interoperability between the plurality of disparate wireless communications systems.

10. The gateway of claim 9 wherein the system further comprises a conversion module coupling the transceiver and the router, wherein the conversion module is configured to convert the wireless communications to the data in a format that is compatible with the digital network.

11. The gateway of claim 10 wherein the conversion module is further configured to convert the data from the format that is compatible with the digital network to a wireless format compatible with the wireless communications.

12. The gateway of claim 9 wherein the interface to the digital network is a satellite interface.

13. The gateway of claim 9 wherein the interface to the digital network is a very small aperture terminal (VSAT) satellite interface.

14. The gateway of claim 9 wherein the interface to the digital network comprises a plurality of redundant interfaces to the digital network.

15. The gateway of claim 9 wherein the transceiver is a digital radio transceiver.

16. The gateway of claim 9 further comprising a second transceiver coupled to the router and configured to transmit and receive wireless communications on a second associated one of the plurality of disparate wireless communications systems.

17. The gateway of claim 9 wherein the router is further configured to route the at least some of the data according to quality-of-service parameters associated with the at least some of the data.

18. The gateway of claim 9 wherein the router is further configured to route the at least some of the data to a network operations center that manages communications with each of the plurality of disparate communications networks.

19. A system for facilitating interoperability between a plurality of disjoint radio systems across a digital network, the system comprising:
a plurality of local gateways, each associated with at least one of the plurality of disjoint radio systems and having an interface to the digital network, a transceiver configured to receive wireless communications on the associated at least one of the plurality of disjoint radio systems, and a router configured to receive data representing the wireless communications from the transceiver and to route at least some of the data on the digital network via the interface; and
a network operations center having an interface to the digital network, wherein the network operations center is configured to process the data received from the digital network to identify an appropriate recipient of the data and to route the processed data over the digital network to a receiving one of the plurality of local gateways associated with the appropriate recipient for transmission on the radio system associated with the receiving local gateway.

20. The system of claim 19 further comprising a regional point-of-presence configured to interlink each of the plurality of local gateways with the network operation center via a plurality of redundant data links.
